(19) United States
(12) Patent Application Publication
(10) Pub. No.: US 2005/0180894 A1
(43) Pub. Date: Aug. 18, 2005

(54) System, method, and product for efficient fluid transfer using and addressable adaptor

(75) Inventors: Christopher Petroff, Groton, MA (US); Raymond W. Leveille, Upton, MA (US)

Correspondence Address: AFFYMETRIX, INC;ATTN: CHIEF IP COUNSEL, LEGAL DEPT., 3380 CENTRAL EXPRESSWAY, SANTA CLARA, CA, 95051, US

(73) Assignee: Affymetrix, INC., Santa Clara, CA (US)

(21) Appl. No.: 11/057,320

(22) Filed: Feb. 11, 2005

Related U.S. Application Data
(60) Provisional application No. 60/544,802, filed on Feb. 13, 2004.

(51) Int. Cl. B01L 11/00

(52) U.S. Cl. 422/103

(57) ABSTRACT

In one embodiment, an adaptor is described that comprises an interface that engages one or more components of an, instrument that introduce a fluid to the interface; a first channel that directs the fluid from the interface to a housing operatively coupled to the adaptor, where the housing comprises a chamber and a biological probe array positioned within the chamber; and a second channel that directs the fluid away from the housing.

### RELATED APPLICATIONS

The present application claims priority to U.S. Provisional Patent Application Ser. No. 60/544,802, titled “System, Method, and Product for Fluid Transfer Using a Removable and Addressable Microfluidic Adaptor”, filed Feb. 13, 2004, which is hereby incorporated by reference herein in its entirety for all purposes.

### FIELD OF THE INVENTION

The present invention relates to systems, methods, and products employed for producing reliable data from multiple experiments performed in a high throughput environment using biological probe arrays. It is generally appreciated that reliability in a high throughput environment includes the repeatability and consistency of processes and methods associated with protocols between each instance of an experiment. It is also generally appreciated that high-throughput environments depend upon the ability to automate steps in the processes and methods where, automation may include the implementation robotic instrumentation or other means of automating and improvements to the efficiency of the processes or methods. In particular, the present invention relates to systems, methods, and products that provide a microfluidic adaptor that may serve as an interface and/or an intermediate device that enables the transfer of small volumes of fluid and/or gas in a highly efficient and repeatable manner. For example, the invention may include an adaptor that is enabled to interface with a cartridge, housing, or holder associated with a biological probe array, where the adaptor includes one or more fluidic connections between the adaptor and one or more ports or apertures on the cartridge, housing, or holder and further that the adaptor comprises one or more ports or apertures that are in fluidic connection to the ports or apertures on the housing and are addressable by one or more automated systems.

### BACKGROUND

Synthesized nucleic acid probe arrays, such as Affymetrix GeneChip® probe arrays, and spotted probe arrays, have been used to generate unprecedented amounts of information about biological systems. For example, the GeneChip® Human Genome U133 Plus 2.0 array available from Affymetrix, Inc. of Santa Clara, Calif., is comprised of a single microarray containing over 1,000,000 unique oligonucleotide features covering more than 47,000 transcripts that represent more than 33,000 human genes. Analysis of expression, genotyping, or other data from such microarrays may lead to the development of new drugs and new diagnostic tools. A need exists to enable high throughput processing and data acquisition for high volumes of probe array experiments. One way to accomplish this is to automate steps and functions that may have traditionally been performed by research personnel that may employ robotic or other types of automated instrumentation. Some steps or functions that are critical to automate what may, for instance, include what is referred to as fluid transfer, hybridization, array transport, and scanning functions.

### SUMMARY OF THE INVENTION

The expanding use of microarray technology is one of the forces driving the development of high throughput instruments and technology. In particular, microarrays and associated instrumentation and computer systems have been developed for rapid and large-scale collection of data about the expression of genes or expressed sequence tags (EST's) in tissue samples, as well as the collection of data associated with the nucleic acid composition of DNA associated with the genotype of an organism, cell, or tissue. Microarray technology and associated instrumentation and computer systems employ a variety of methods to obtain the accurate data from microarray experiments. Processing and scanning of arrays are essential steps in microarray experiments and relies, amongst numerous other factors, on the ability to automate processes traditionally performed by laboratory personnel; this being of vital importance to obtain reliable and reproducible data from a high volume of experiments.

In one embodiment, an adaptor is described that comprises an interface that engages one or more components of an instrument that introduce a fluid to the interface; a first channel that directs the fluid from the interface to a housing operatively coupled to the adaptor, where the housing comprises a chamber and a biological probe array positioned within the chamber; and a second channel that directs the fluid away from the housing.

Also, a method of fluid transfer is described that comprises engaging one or more components of an instrument to an interface of an adaptor; introducing a fluid to the interface; directing the fluid from the interface to a housing operatively coupled to the adaptor, where the housing comprises a chamber and a biological probe array positioned within the chamber; and directing the fluid away from the housing.

Additionally, a processing system is described that comprises a robotic instrument comprising one or more components to perform one or more processing steps; a computer comprising an instrument control application that coordinates each processing step; and a holding device that registers a plurality of adaptors each operatively coupled to a housing, where each adaptor comprises: an interface that engages a component of the one or more components, where the component introduces a fluid to the interface according to at least one of the one or more processing steps; a first channel that directs the fluid from the interface to the housing, where the housing comprises a chamber and a biological probe array positioned within the chamber; and a second channel that directs the fluid away from the housing.

The above implementations are not necessarily inclusive or exclusive of each other and may be combined in any manner that is non-conflicting and otherwise possible, whether they be presented in association with a same, or a different, aspect or implementation. The description of one implementation is not intended to be limiting with respect to other implementations. Also, any one or more function, step, operation, or technique described elsewhere in this specification may, in alternative implementations, be combined with any one or more function, step, operation, or technique described in the summary. Thus, the above implementations are illustrative rather than limiting.

### BRIEF DESCRIPTION OF THE DRAWINGS

The above and further advantages will be more clearly appreciated from the following detailed description when taken in conjunction with the accompanying drawings. In the drawings, like reference numerals indicate like structures or method steps and the leftmost one or two digits of a reference numeral indicate the number of the figure in which the referenced element first appears (for example, the element 100 appears first in FIG. 1). In functional block diagrams, rectangles generally indicate functional elements, parallelograms generally indicate data, rectangles with curved sides generally indicate stored data, rectangles with a pair of double borders generally indicate predefined functional elements, and keystone shapes generally indicate manual operations. In method flow charts, rectangles generally indicate method steps and diamond shapes generally indicate decision elements. All of these conventions, however, are intended to be typical or illustrative, rather than limiting.

FIG. 1 is a functional block diagram of one embodiment of a computer system that provides instrument control to a hybridization station, autoloader, and scanner instruments, as well as one embodiment of a microfluidic adaptor associated with a probe array;

FIG. 2 is a simplified graphical representation of one embodiment of a front view perspective of a housing comprising a probe array chamber operatively coupled to the microfluidic adaptor of FIG. 1;

FIG. 3 is a simplified graphical representation of one embodiment of the rear view perspective of the housing and microfluidic adaptor of FIG. 2 illustrating a plurality of microfluidic channels in the adaptor;

FIG. 4A is a simplified graphical representation of one embodiment of the microfluidic adaptor of FIGS. 1 through 3 comprising a plurality of fluid interfaces and holding elements;

FIG. 4B is a simplified graphical representation of a second embodiment of a microfluidic adaptor illustrating a cutaway view of the adaptor that comprises a fluid transfer channel, a vent channel, and a waste channel coupled with to a waste port;

FIG. 5 is a simplified graphical representation of one embodiment of the microfluidic adaptor of FIGS. 1 through 4B comprising an instrument interface;

FIG. 6 is a simplified graphical representation of one embodiment of the instrument interface of FIG. 5 comprising a plurality of ports each operatively coupled to a microfluidic channel; and

FIG. 7 is a simplified graphical representation of one embodiment of a processing tray enabled to provide positional registration of a plurality of adaptor/housing embodiments and a means of transport for said adaptor/housing embodiments.

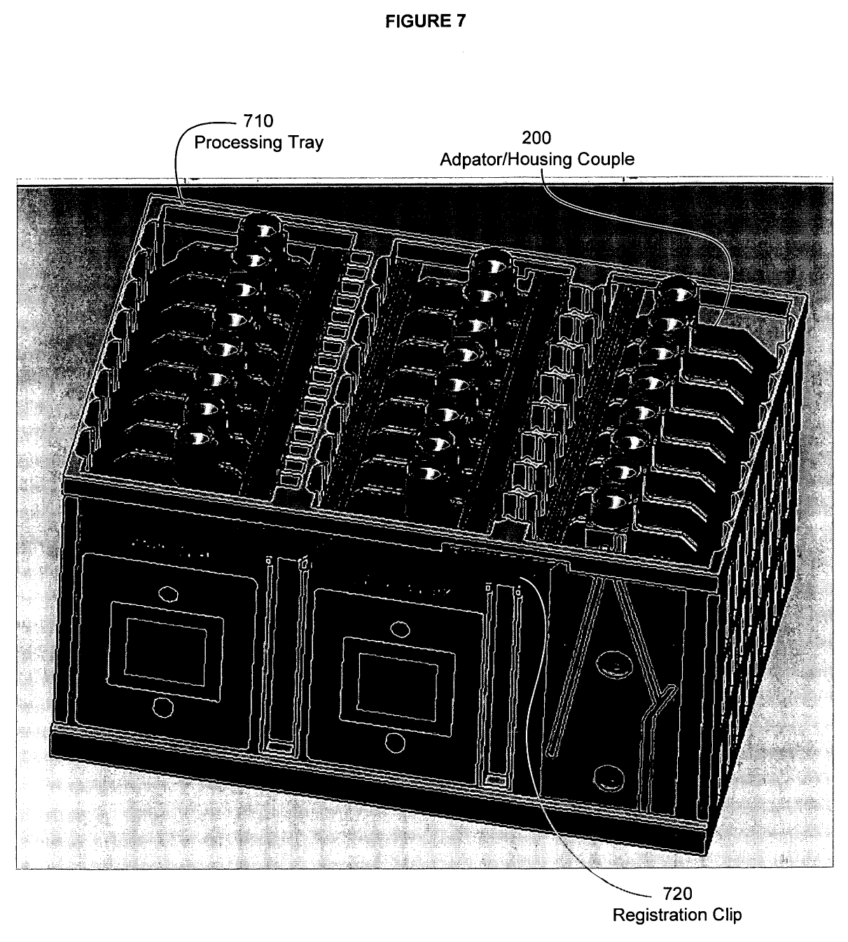

### DETAILED DESCRIPTION

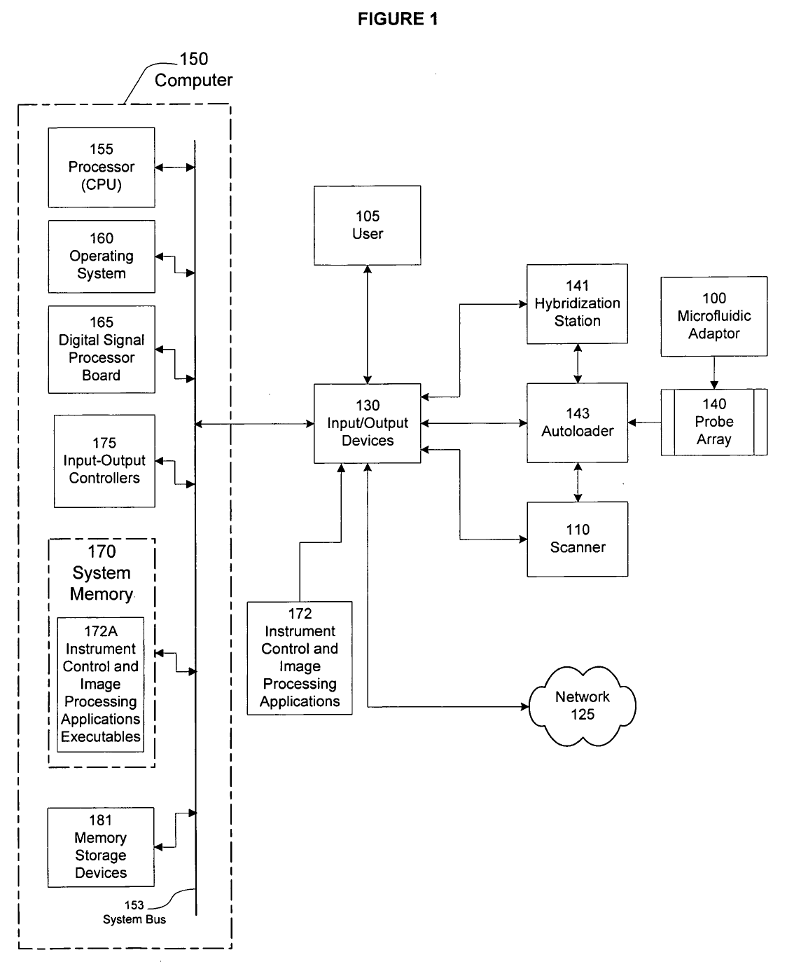

The present invention may be embodied as a system for providing an adaptor for reversibly transferring small volumes of fluid between an automated processing instrument and a cartridge or holder associated with a biological probe array, where the automated processing instrument interacts with a specialized port associated with the adaptor and the adaptor is further enabled to interact with the cartridge or housing. Illustrative embodiments are now described with reference to the adaptor and an automated processing instrument, such as hybridization station 141, as illustrated in FIG. 1. Also illustrated in FIG. 1 is computer 150 having instrument control software stored and executed thereon, such as instrument control and image processing applications executables 172A. The operations of this computer system and of instrument control and image processing applications executables 172A such as, for instance, the GeneChip® Operating Software (GCOS) available from Affymetrix®, Inc. of Santa Clara Calif., executed on computers of this system, are illustrated in the context of high throughput processing and image acquisition from a plurality of biological probe arrays. This data generating includes the scanning of probe arrays by scanner 110 and the processing of the resulting information (and other data) by software executing on representative computer 150 such as instrument control and image processing applications executables 172A. Further, data handling and other aspects of management is carried out by the image processing applications executables 172A enabled to utilize local and remote resources such as available on a server.

a) General

### DETAILED DESCRIPTION OF THE INVENTION

a) General

The present invention has many preferred embodiments and relies on many patents, applications and other references for details known to those of the art. Therefore, when a patent, application, or other reference is cited or repeated below, it should be understood that it is incorporated by reference in its entirety for all purposes as well as for the proposition that is recited.

As used in this application, the singular form “a,” “an,” and “the” include plural references unless the context clearly dictates otherwise. For example, the term “an agent” includes a plurality of agents, including mixtures thereof.

An individual is not limited to a human being but may also be other organisms including but not limited to mammals, plants, bacteria, or cells derived from any of the above.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995) Biochemistry (4th Ed.) Freeman, New York, Gait, “Oligonucleotide Synthesis: A Practical Approach” 1984, IRL Press, London, Nelson and Cox (2000), Lehninger, Principles of Biochemistry 3^{rd} Ed., W. H. Freeman Pub., New York, N.Y. and Berg et al. (2002) Biochemistry, 5^{th} Ed., W. H. Freeman Pub., New York, N.Y., all of which are herein incorporated in their entirety by reference for all purposes.

The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, in PCT Applications Nos. PCT/US99/00730 (International Publication Number WO 99/36760) and PCT/US01/04285 (International Publication Number WO 01/58593), which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165, and 5,959,098. Nucleic acid arrays are described in many of the above patents, but the same techniques are applied to polypeptide arrays.

Nucleic acid arrays that are useful in the present invention include those that are commercially available from Affymetrix (Santa Clara, Calif.) under the brand name GeneChip®. Example arrays are shown on the website at affymetrix.com.

The present invention also contemplates many uses for polymers attached to solid substrates. These uses include gene expression monitoring, profiling, library screening, genotyping and diagnostics. Gene expression monitoring and profiling methods can be shown in U.S. Pat. Nos. 5,800,992, 6,013,449, 6,020,135, 6,033,860, 6,040,138, 6,177,248 and 6,309,822. Genotyping and uses therefore are shown in U.S. Ser. Nos. 10/442,021, 10/013,598 (U.S. patent application Publication 20030036069), and U.S. Pat. Nos. 5,856,092, 6,300,063, 5,858,659, 6,284,460, 6,361,947, 6,368,799 and 6,333,179. Other uses are embodied in U.S. Pat. Nos. 5,871,928, 5,902,723, 6,045,996, 5,541,061, and 6,197,506.

The present invention also contemplates sample preparation methods in certain preferred embodiments. Prior to or concurrent with genotyping, the genomic sample may be amplified by a variety of mechanisms, some of which may employ PCR. See, e.g., PCR Technology: Principles and Applications for DNA Amplification (Ed. H. A. Erlich, Freeman Press, NY, N.Y., 1992); PCR Protocols: A Guide to Methods and Applications (Eds. Innis, et al., Academic Press, San Diego, Calif., 1990); Mattila et al., Nucleic Acids Res. 19, 4967 (1991); Eckert et al., PCR Methods and Applications 1, 17 (1991); PCR (Eds. McPherson et al., IRL Press, Oxford); and U.S. Pat. Nos. 4,683,202, 4,683,195, 4,800,159 4,965,188, and 5,333,675, and each of which is incorporated herein by reference in their entireties for all purposes. The sample may be amplified on the array. See, for example, U.S. Pat. No. 6,300,070 and U.S. Ser. No. 09/513,300, which are incorporated herein by reference.

Other suitable amplification methods include the ligase chain reaction (LCR) (e.g., Wu and Wallace, Genomics 4, 560 (1989), Landegren et al., Science 241, 1077 (1988) and Barringer et al. Gene 89:117 (1990)), transcription amplification (Kwoh et al., Proc. Natl. Acad. Sci. USA 86, 1173 (1989) and WO88/10315), self-sustained sequence replication (Guatelli et al., Proc. Nat. Acad. Sci. USA, 87, 1874 (1990) and WO90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5, 413,909, 5,861,245) and nucleic acid based sequence amplification (NABSA). (See, U.S. Pat. Nos. 5,409,818, 5,554,517, and 6,063,603, each of which is incorporated herein by reference). Other amplification methods that may be used are described in, U.S. Pat. Nos. 5,242,794, 5,494,810, 4,988,617 and in U.S. Ser. No. 09/854,317, each of which is incorporated herein by reference.

Additional methods of sample preparation and techniques for reducing the complexity of a nucleic sample are described in Dong et al., Genome Research 11, 1418 (2001), in U.S. Pat. Nos. 6,361,947, 6,391,592 and U.S. Ser. Nos. 09/916,135, 09/920,491 (U.S. patent application Publication 20030096235), Ser. No. 09/910,292 (U.S. patent application Publication 20030082543), and Ser. No. 10/013,598.

Methods for conducting polynucleotide hybridization assays have been well developed in the art. Hybridization assay procedures and conditions will vary depending on the application and are selected in accordance with the general binding methods known including those referred to in: Maniatis et al. Molecular Cloning: A Laboratory Manual (2^{nd} Ed. Cold Spring Harbor, N.Y., 1989); Berger and Kimmel Methods in Enzymology, Vol. 152, Guide to Molecular Cloning Techniques (Academic Press, Inc., San Diego, Calif., 1987); Young and Davism, P.N.A.S, 80: 1194 (1983). Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference

The present invention also contemplates signal detection of hybridization between ligands in certain preferred embodiments. See U.S. Pat. Nos. 5,143,854, 5,578,832; 5,631,734; 5,834,758; 5,936,324; 5,981,956; 6,025,601; 6,141,096; 6,185,030; 6,201,639; 6,218,803; and 6,225,625, in U.S. patent application Ser. Nos. 10/389,194, 10/913,102 and in PCT Application PCT/US99/06097 (published as WO99/47964), each of which also is hereby incorporated by reference in its entirety for all purposes.

Methods and apparatus for signal detection and processing of intensity data are disclosed in, for example, U.S. Pat. Nos. 5,143,854, 5,547,839, 5,578,832, 5,631,734, 5,800,992, 5,834,758; 5,856,092, 5,902,723, 5,936,324, 5,981,956, 6,025,601, 6,090,555, 6,141,096, 6,185,030, 6,201,639; 6,218,803; and 6,225,625, in U.S. patent application Ser. Nos. 10/389,194, 10/913,102 and in PCT Application PCT/US99/06097 (published as WO99/47964), each of which also is hereby incorporated by reference in its entirety for all purposes.

The practice of the present invention may also employ conventional biology methods, software and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, e.g. Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2^{nd} ed., 2001). See U.S. Pat. No. 6,420,108.

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170.

Additionally, the present invention may have preferred embodiments that include methods for providing genetic information over networks such as the Internet as shown in U.S. Ser. Nos. 10/197,621, 10/063,559 (U.S. publication No. 20020183936), Ser. Nos. 10/065,856, 10/065,868, 10/328,818, 10/328,872, 10/423,403, and 60/482,389.

b) Definitions

An “array” is an intentionally created collection of molecules which can be prepared either synthetically or biosynthetically. The molecules in the array can be identical or different from each other. The array can assume a variety of formats, e.g., libraries of soluble molecules; libraries of compounds tethered to resin beads, silica chips, or other solid supports.

Nucleic acid library or array is an intentionally created collection of nucleic acids which can be prepared either synthetically or biosynthetically and screened for biological activity in a variety of different formats (e.g., libraries of soluble molecules; and libraries of oligos tethered to resin beads, silica chips, or other solid supports). Additionally, the term “array” is meant to include those libraries of nucleic acids which can be prepared by spotting nucleic acids of essentially any length (e.g., from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

Biopolymer or biological polymer: is intended to mean repeating units of biological or chemical moieties. Representative biopolymers include, but are not limited to, nucleic acids, oligonucleotides, amino acids, proteins, peptides, hormones, oligosaccharides, lipids, glycolipids, lipopolysaccharides, phospholipids, synthetic analogues of the foregoing, including, but not limited to, inverted nucleotides, peptide nucleic acids, Meta-DNA, and combinations of the above. “Biopolymer synthesis” is intended to encompass the synthetic production, both organic and inorganic, of a biopolymer.

Related to a bioploymer is a “biomonomer” which is intended to mean a single unit of biopolymer, or a single unit which is not part of a biopolymer. Thus, for example, a nucleotide is a biomonomer within an oligonucleotide biopolymer, and an amino acid is a biomonomer within a protein or peptide biopolymer; avidin, biotin, antibodies, antibody fragments, etc., for example, are also biomonomers. initiation Biomonomer: or “initiator biomonomer⇄ is meant to indicate the first biomonomer which is covalently attached via reactive nucleophiles to the surface of the polymer, or the first biomonomer which is attached to a linker or spacer arm attached to the polymer, the linker or spacer arm being attached to the polymer via reactive nucleophiles.

Complementary: Refers to the hybridization or base pairing between nucleotides or nucleic acids, such as, for instance, between the two strands of a double stranded DNA molecule or between an oligonucleotide primer and a primer binding site on a single stranded nucleic acid to be sequenced or amplified. Complementary nucleotides are, generally, A and T (or A and U), or C and G. Two single stranded RNA or DNA molecules are said to be complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, complementarity exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, M. Kanehisa Nucleic Acids Res. 12:203 (1984), incorporated herein by reference.

Combinatorial Synthesis Strategy: A combinatorial synthesis strategy is an ordered strategy for parallel synthesis of diverse polymer sequences by sequential addition of reagents which may be represented by a reactant matrix and a switch matrix, the product of which is a product matrix. A reactant matrix is a 1 column by m row matrix of the building blocks to be added. The switch matrix is all or a subset of the binary numbers, preferably ordered, between 1 and m arranged in columns. A “binary strategy” is one in which at least two successive steps illuminate a portion, often half, of a region of interest on the substrate. In a binary synthesis strategy, all possible compounds which can be formed from an ordered set of reactants are formed. In most preferred embodiments, binary synthesis refers to a synthesis strategy which also factors a previous addition step. For example, a strategy in which a switch matrix for a masking strategy halves regions that were previously illuminated, illuminating about half of the previously illuminated region and protecting the remaining half (while also protecting about half of previously protected regions and illuminating about half of previously protected regions). It will be recognized that binary rounds may be interspersed with non-binary rounds and that only a portion of a substrate may be subjected to a binary scheme. A combinatorial “masking” strategy is a synthesis which uses light or other spatially selective deprotecting or activating agents to remove protecting groups from materials for addition of other materials such as amino acids.

Effective amount refers to an amount sufficient to induce a desired result.

Genome is all the genetic material in the chromosomes of an organism. DNA derived from the genetic material in the chromosomes of a particular organism is genomic DNA. A genomic library is a collection of clones made from a set of randomly generated overlapping DNA fragments representing the entire genome of an organism.

Hybridization conditions will typically include salt concentrations of less than about 1M, more usually less than about 500 mM and preferably less than about 200 mM. Hybridization temperatures can be as low as 5. degree. C., but are typically greater than 22. degree. C., more typically greater than about 30. degree. C., and preferably in excess of about 37. degree. C. Longer fragments may require higher hybridization temperatures for specific hybridization. As other factors may affect the stringency of hybridization, including base composition and length of the complementary strands, presence of organic solvents and extent of base mismatching, the combination of parameters is more important than the absolute measure of any one alone.

Hybridizations, e.g., allele-specific probe hybridizations, are generally performed under stringent conditions. For example, conditions where the salt concentration is no more than about 1 Molar (M) and a temperature of at least 25 degrees-Celsius (° C.), e.g., 750 mM NaCl, 50 mM NaPhosphate, 5 mM EDTA, pH 7.4 (5×SSPE) and a temperature of from about 25 to about 30° C.

Hybridizations are usually performed under stringent conditions, for example, at a salt concentration of no more than 1 M and a temperature of at least 25° C. For example, conditions of 5×SSPE (750 mM NaCl, 50 mM NaPhosphate, 5 mM EDTA, pH 7.4) and a temperature of 25-30° C. are suitable for allele-specific probe hybridizations. For stringent conditions, see, for example, Sambrook, Fritsche and Maniatis. “Molecular Cloning A laboratory Manual” 2^{nd} Ed. Cold Spring Harbor Press (1989) which is hereby incorporated by reference in its entirety for all purposes above.

The term “hybridization” refers to the process in which two single-stranded polynucleotides bind non-covalently to form a stable double-stranded polynucleotide; triple-stranded hybridization is also theoretically possible. The resulting (usually) double-stranded polynucleotide is a “hybrid.” The proportion of the population of polynucleotides that forms stable hybrids is referred to herein as the “degree of hybridization.”

Hybridization probes are oligonucleotides capable of binding in a base-specific manner to a complementary strand of nucleic acid. Such probes include peptide nucleic acids, as described in Nielsen et al., Science 254, 1497-1500 (1991), and other nucleic acid analogs and nucleic acid mimetics.

Hybridizing specifically to: refers to the binding, duplexing, or hybridizing of a molecule only to a particular nucleotide sequence or sequences under stringent conditions when that sequence is present in a complex mixture (e.g., total cellular) DNA or RNA.

Isolated nucleic acid is an object species invention that is the predominant species present (i.e., on a molar basis it is more abundant than any other individual species in the composition). Preferably, an isolated nucleic acid comprises at least about 50, 80 or 90%. (on a molar basis) of all macromolecular species present. Most preferably, the object species is purified to essential homogeneity (contaminant species cannot be detected in the composition by conventional detection methods).

Ligand: A ligand is a molecule that is recognized by a particular receptor. The agent bound by or reacting with a receptor is called a “ligand,” a term which is definitionally meaningful only in terms of its counterpart receptor. The term “ligand” does not imply any particular molecular size or other structural or compositional feature other than that the substance in question is capable of binding or otherwise interacting with the receptor. Also, a ligand may serve either as the natural ligand to which the receptor binds, or as a functional analogue that may act as an agonist or antagonist. Examples of ligands that can be investigated by this invention include, but are not restricted to, agonists and antagonists for cell membrane receptors, toxins and venoms, viral epitopes, hormones (e.g., opiates, steroids, etc.), hormone receptors, peptides, enzymes, enzyme substrates, substrate analogs, transition state analogs, cofactors, drugs, proteins, and antibodies.

Linkage disequilibrium or allelic association means the preferential association of a particular allele or genetic marker with a specific allele, or genetic marker at a nearby chromosomal location more frequently than expected by chance for any particular allele frequency in the population. For example, if locus X has alleles a and b, which occur equally frequently, and linked locus Y has alleles c and d, which occur equally frequently, one would expect the combination ac to occur with a frequency of 0.25. If ac occurs more frequently, then alleles a and c are in linkage disequilibrium. Linkage disequilibrium may result from natural selection of certain combination of alleles or because an allele has been introduced into a population too recently to have reached equilibrium with linked alleles.

Mixed population or complex population: refers to any sample containing both desired and undesired nucleic acids. As a non-limiting example, a complex population of nucleic acids may be total genomic DNA, total genomic RNA or a combination thereof. Moreover, a complex population of nucleic acids may have been enriched for a given population but include other undesirable populations. For example, a complex population of nucleic acids may be a sample which has been enriched for desired messenger RNA (mRNA) sequences but still includes some undesired ribosomal RNA sequences (rRNA).

Monomer: refers to any member of the set of molecules that can be joined together to form an oligomer or polymer. The set of monomers useful in the present invention includes, but is not restricted to, for the example of (poly)peptide synthesis, the set of L-amino acids, D-amino acids, or synthetic amino acids. As used herein, “monomer” refers to any member of a basis set for synthesis of an oligomer. For example, dimers of L-amino acids form a basis set of 400 “monomers” for synthesis of polypeptides. Different basis sets of monomers may be used at successive steps in the synthesis of a polymer. The term “monomer” also refers to a chemical subunit that can be combined with a different chemical subunit to form a compound larger than either subunit alone.

mRNA or mRNA transcripts: as used herein, include, but not limited to pre-mRNA transcript(s), transcript processing intermediates, mature mRNA(s) ready for translation and transcripts of the gene or genes, or nucleic acids derived from the mRNA transcript(s). Transcript processing may include splicing, editing and degradation. As used herein, a nucleic acid derived from an mRNA transcript refers to a nucleic acid for whose synthesis the mRNA transcript or a subsequence thereof has ultimately served as a template. Thus, a cDNA reverse transcribed from an mRNA, an RNA transcribed from that cDNA, a DNA amplified from the cDNA, an RNA transcribed from the amplified DNA, etc., are all derived from the mRNA transcript and detection of such derived products is indicative of the presence and/or abundance of the original transcript in a sample. Thus, mRNA derived samples include, but are not limited to, mRNA transcripts of the gene or genes, cDNA reverse transcribed from the mRNA, cRNA transcribed from the cDNA, DNA amplified from the genes, RNA transcribed from amplified DNA, and the like.

Nucleic acid library or array is an intentionally created collection of nucleic acids which can be prepared either synthetically or biosynthetically and screened for biological activity in a variety of different formats (e.g., libraries of soluble molecules; and libraries of oligos tethered to resin beads, silica chips, or other solid supports). Additionally, the term “array” is meant to include those libraries of nucleic acids which can be prepared by spotting nucleic acids of essentially any length (e.g., from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

Nucleic acids according to the present invention may include any polymer or oligomer of pyrimidine and purine bases, preferably cytosine, thymine, and uracil, and adenine and guanine, respectively. See Albert L. Lehninger, PRINCIPLES OF BIOCHEMISTiY, at 793-800 (Worth Pub. 1982). Indeed, the present invention contemplates any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

An “oligonucleotide” or “polynucleotide” is a nucleic acid ranging from at least 2, preferable at least 8, and more preferably at least 20 nucleotides in length or a compound that specifically hybridizes to a polynucleotide. Polynucleotides of the present invention include sequences of deoxyribonucleic acid (DNA) or ribonucleic acid (RNA) which may be isolated from natural sources, recombinantly produced or artificially synthesized and mimetics thereof. A further example of a polynucleotide of the present invention may be peptide nucleic acid (PNA). The invention also encompasses situations in which there is a nontraditional base pairing such as Hoogsteen base pairing which has been identified in certain tRNA molecules and postulated to exist in a triple helix. “Polynucleotide” and “oligonucleotide” are used interchangeably in this application.

Probe: A probe is a surface-immobilized molecule that can be recognized by a particular target. See U.S. Pat. No. 6,582,908 for an example of arrays having all possible combinations of probes with 10, 12, and more bases. Examples of probes that can be investigated by this invention include, but are not restricted to, agonists and antagonists for cell membrane receptors, toxins and venoms, viral epitopes, hormones (e.g., opioid peptides, steroids, etc.), hormone receptors, peptides, enzymes, enzyme substrates, cofactors, drugs, lectins, sugars, oligonucleotides, aptamers, nucleic acids, oligosaccharides, proteins, and monoclonal antibodies.

Primer is a single-stranded oligonucleotide capable of acting as a point of initiation for template-directed DNA synthesis under suitable conditions e.g., buffer and temperature, in the presence of four different nucleoside triphosphates and an agent for polymerization, such as, for example, DNA or RNA polymerase or reverse transcriptase. The length of the primer, in any given case, depends on, for example, the intended use of the primer, and generally ranges from 15 to 30 nucleotides. Short primer molecules generally require cooler temperatures to form sufficiently stable hybrid complexes with the template. A primer need not reflect the exact sequence of the template but must be sufficiently complementary to hybridize with such template. The primer site is the area of the template to which a primer hybridizes. The primer pair is a set of primers including a 5′ upstream primer that hybridizes with the 5′ end of the sequence to be amplified and a 3′ downstream primer that hybridizes with the complement of the 3′ end of the sequence to be amplified.

Polymorphism refers to the occurrence of two or more genetically determined alternative sequences or alleles in a population. A polymorphic marker or site is the locus at which divergence occurs. Preferred markers have at least two alleles, each occurring at frequency of greater than 1%, and more preferably greater than 10% or 20% of a selected population. A polymorphism may comprise one or more base changes, an insertion, a repeat, or a deletion. A polymorphic locus may be as small as one base pair. Polymorphic markers include restriction fragment length polymorphisms, variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wildtype form. Diploid organisms may be homozygous or heterozygous for allelic forms. A diallelic polymorphism has two forms. A triallelic polymorphism has three forms. Single nucleotide polymorphisms (SNPs) are included in polymorphisms.

Receptor: A molecule that has an affinity for a given ligand. Receptors may be naturally-occurring or manmade molecules. Also, they can be employed in their unaltered state or as aggregates with other species. Receptors may be attached, covalently or noncovalently, to a binding member, either directly or via a specific binding substance. Examples of receptors which can be employed by this invention include, but are not restricted to, antibodies, cell membrane receptors, monoclonal antibodies and antisera reactive with specific antigenic determinants (such as on viruses, cells or other materials), drugs, polynucleotides, nucleic acids, peptides, cofactors, lectins, sugars, polysaccharides, cells, cellular membranes, and organelles. Receptors are sometimes referred to in the art as anti-ligands. As the term receptors is used herein, no difference in meaning is intended. A “Ligand Receptor Pair” is formed when two macromolecules have combined through molecular recognition to form a complex. Other examples of receptors which can be investigated by this invention include but are not restricted to those molecules shown in U.S. Pat. No. 5,143,854, which is hereby incorporated by reference in its entirety.

“Solid support”, “support”, and “substrate” are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. See U.S. Pat. No. 5,744,305 for exemplary substrates.

Target: A molecule that has an affinity for a given probe. Targets may be naturally-occurring or man-made molecules. Also, they can be employed in their unaltered state or as aggregates with other species. Targets may be attached, covalently or noncovalently, to a binding member, either directly or via a specific binding substance. Examples of targets which can be employed by this invention include, but are not restricted to, antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles. Targets are sometimes referred to in the art as anti-probes. As the term targets is used herein, no difference in meaning is intended. A “Probe Target Pair” is formed when two macromolecules have combined through molecular recognition to form a complex.

c) Embodiments of the Present Invention

Computer 150: Computer 150 may be any type of computer platform such as a workstation, a personal computer, a server, or any other present or future computer. Computer 150 typically includes known components such as a processor 155, an operating system 160, digital signal processor board 165, system memory 170, memory storage devices 181, input-output controllers 175, and input/output devices 130. In particular, output controllers of input-output controllers 175 could include controllers for any of a variety of known display devices, network cards, and other devices well known to those of ordinary skill in the relevant art. Input/Output Devices 130 may include display devices that provides visual information, this information typically may be logically and/or physically organized as an array of pixels. A Graphical user interface (GUI) controller may also be included that may comprise any of a variety of known or future software programs for providing graphical input and output interfaces to a user, such as user 105, and for processing user inputs.

It will be understood by those skilled in the relevant art that there are many possible configurations of the components of computer 150 and that some components that may typically be included in computer 150 are not shown, such as cache memory, a data backup unit, and many other devices. Processor 155 may be a commercially available processor such as an Itanium® or Pentium® processor made by Intel Corporation, a SPARC® processor made by Sun Microsystems, an Athalon™ or Opteron™ processor made by AMD corporation, or it may be one of other processors that are or will become available. Processor 155 executes operating system 160, which may be, for example, a Windows®-type operating system (such as Windows XP®, Windows NT® 4.0 with SP6a) from the Microsoft Corporation; a Unix® or Linux-type operating system available from many vendors or what is referred to as an open source; another or a future operating system; or some combination thereof. Operating system 160 interfaces with firmware and hardware in a well-known manner, and facilitates processor 155 in coordinating and executing the functions of various computer programs that may be written in a variety of programming languages. Operating system 160, typically in cooperation with processor 155, coordinates and executes functions of the other components of computer 150. Operating system 160 also provides scheduling, input-output control, file and data management, memory management, and communication control and related services, all in accordance with known techniques.

System memory 170 may be any of a variety of known or future memory storage devices. Examples include any commonly available random access memory (RAM), magnetic medium such as a resident hard disk or tape, an optical medium such as a read and write compact disc, or other memory storage device. Memory storage device 181 may be any of a variety of known or future devices, including a compact disk drive, a tape drive, a removable hard disk drive, or a diskette drive. Such types of memory storage device 181 typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory 170 and/or the program storage device used in conjunction with memory storage device 181.

In some embodiments, a computer program product is described comprising a computer usable medium having control logic (computer software program, including program code) stored therein. The control logic, when executed by processor 155, causes processor 155 to perform functions described herein. In other embodiments, some functions are implemented primarily in hardware using, for example, a hardware state machine. Implementation of the hardware state machine so as to perform the functions described herein will be apparent to those skilled in the relevant arts.

Input-output controllers 175 could include any of a variety of known devices for accepting and processing information from a user, whether a human or a machine, whether local or remote. Such devices include, for example, modem cards, network interface cards, sound cards, or other types of controllers for any of a variety of known input devices. Output controllers of input-output controllers 175 could include controllers for any of a variety of known display devices for presenting information to a user, whether a human or a machine, whether local or remote. In the illustrated embodiment, the functional elements of computer 150 communicate with each other via system bus 153. Some of these communications may be accomplished in alternative embodiments using network or other types of remote communications.

As will be evident to those skilled in the relevant art, applications/executables 172A as described in detail below, if implemented in software, may be loaded into system memory 170 and/or memory storage device 181. All or portions of applications/executables 172A may also reside in a read-only memory or similar device of memory storage device 181, such devices not requiring that applications/executables 172A first be loaded through input-output controllers 175. It will be understood by those skilled in the relevant art that applications/executables 172A, or portions of it, may be loaded by processor 155 in a known manner into system memory 170, or cache memory (not shown), or both, as advantageous for execution.

Network 125 may be one among the many various types of networks well known to those of ordinary skill in the art. In one possible embodiment, network 125 may comprise a Local or Wide area network and may, for example, operate according to what is commonly referred to as a TCP/IP protocol suite. Network 125 may also include other type of internet, or intranet architecture. Some examples of possible configurations of network 125 may include data links comprising what may be referred to as an Ethernet, token ring (that may include FDDI or CDDI), WiFi (i.e. 802.11 a/b/g types of wireless network), PPP, ISDN, or other types currently known in the art or that may be developed in the future. Instrument control and image processing applications 172: Instrument control and image processing applications 172 may be any of a variety of known or future image processing applications. Examples of applications 172 include Affymetrix® Microarray Suite, Affymetrix® GeneChip® Operating Software (hereafter referred to as GCOS), and Affymetrix® Jaguar™ software, noted above. Applications 172 may be loaded into system memory 170 and/or memory storage device 181 through one of input devices 130. Applications 172 as loaded into system memory 170 are shown in FIG. 1 as instrument control and image processing applications executables 172A.

Embodiments of applications 172 includes executables 172A being stored in system memory 170 of an implementation of computer 150 that includes what is commonly referred to by those of ordinary skill in the related art as a client workstation. It will be appreciated that all capabilities, operations, and functions as described below with respect to applications 172 may be executed by executables 172A.

Some embodiments of applications 172 may provide a single interface for communication between computer 150 and one or more servers and/or server applications such as, for instance, GeneChip® Operating Software Server (GCOS Server). Applications 172 could additionally provide an interface between computer 150 and one or more of user 105, and one or more instruments such as scanner 110, autoloader 143, and/or hybridization station 141. In some embodiments, applications 172 may also provide an interactive Graphical User Interface (GUI) for communication between applications 172 and user 105 where, for instance the GUI may provide information and selectable options for instrument control or parameters, experiment information or parameters, or other related information. For example, the interface of applications 172 may communicate with and provide control to one or more elements of the one or more servers, one or more of computers 150, and the one or more instruments. Also in the present example, the interface of applications 172 may include control of and/or transfer of information pertaining to one or more instrument features. The instrument features may include any one of experiment or instrument status; process steps or parameters; system or component parameters; power ON, OFF, or Standby states; or other relevant information. For example, the instrument features could be under the control of or an element of the interface where a user may input desired control commands and/or receive the instrument feature information via a GUI. Additionally, computer 150 could be located locally or remotely to the one or more servers and/or one or more other embodiments of computer 150, and/or one or more instruments while providing the control features of applications 172

In alternative implementations, applications 172 may be executed on a server, or on one or more other computer platforms connected directly or indirectly (e.g., via another network, including the Internet or an Intranet) to network 125.

In some embodiments, image data is operated upon by applications 172 to generate intermediate results. Examples of intermediate results include so-called cell intensity files (*.cel) and chip files (*.chp) generated by Affymetrix® GeneChip® Operating Software or Affymetrix® Microarray Suite (as described, for example, in U.S. patent application, Ser. Nos. 10/219,882, and 10/764,663, titled “System, Method and Computer Software Product for Instrument Control, Data Acquisition, Analysis, Management and Storage”, filed Jan. 26, 2004, both of which are hereby incorporated herein by reference in their entireties for all purposes) and spot files (*.spt) generated by Affymetrix® Jaguar™ software (as described, for example, in PCT Application PCT/US 01/26390 and in U.S. patent applications, Ser. Nos. 09/681,819, 09/682,071, 09/682,074, and 09/682,076, all of which are hereby incorporated by reference herein in their entireties for all purposes). For convenience, the term “file” often is used herein to refer to data generated or used by applications 172 and executable counterparts of other applications, but any of a variety of alternative techniques known in the relevant art for storing, conveying, and/or manipulating data may be employed.

For example, applications 172 receives image data derived from a GeneChip® probe array and generates a cell intensity file. This file contains, for each probe scanned by scanner 110, a single value representative of the intensities of pixels measured by scanner 110 for that probe. Thus, this value is a measure of the abundance of tagged mRNA's present in the target that hybridized to the corresponding probe. Many such mRNA's may be present in each probe, as a probe on a GeneChip® probe array may include, for example, millions of oligonucleotides designed to detect the mRNA's. As noted, another file illustratively assumed to be generated by applications 172 is a chip file. In the present example, in which applications 172 include Affymetrix® GeneChip® Operating Software, the chip file is derived from analysis of the cell file combined in some cases with information derived from lab data and/or library files that specify details regarding the sequences and locations of probes and controls. The resulting data stored in the chip file includes degrees of hybridization, absolute and/or differential (over two or more experiments) expression, genotype comparisons, detection of polymorphisms and mutations, and other analytical results.

In another example, in which applications 172 includes Affymetrix® Jaguar™ software operating on image data from a spotted probe array, the resulting spot file includes the intensities of labeled targets that hybridized to probes in the array. Further details regarding cell files, chip files, and spot files are provided in U.S. patent application Nos. 09/682,098, 09/682,071, and 10/126,468, incorporated by reference above. As will be appreciated by those skilled in the relevant art, the preceding and following descriptions of files generated by applications 172 are exemplary only, and the data described, and other data, may be processed, combined, arranged, and/or presented in many other ways.

User 105 and/or automated data input devices or programs (not shown) may provide data related to the design or conduct of experiments. As one further non-limiting example related to the processing of an Affymetrix® GeneChip® probe array, the user may specify an Affymetrix catalogue or custom chip type (e.g., Human Genome U95Av2 chip) either by selecting from a predetermined list presented by applications 172 such as the GCOS software, or by scanning a bar code related to a chip to read its type. Applications 172 may associate the chip type with various scanning parameters stored in data tables including the area of the chip that is to be scanned, the location of chrome borders on the chip used for auto-focusing, the wavelength or intensity of laser light to be used in reading the chip, and so on. As noted, applications 172 may apply some of this data in the generation of intermediate results. For example, information about the dyes may be incorporated into determinations of relative expression.

Scanner 110: Labeled targets hybridized to probe arrays may be detected using various devices, sometimes referred to as scanners, as described above with respect to methods and apparatus for signal detection. An illustrative device is shown in FIG. 1 as scanner 110, where scanner 100 may be enabled to accept one or more embodiments of adaptor/housing couple 200 for scanning. For example, scanners image the targets by detecting fluorescent or other emissions from labels associated with target molecules, or by detecting transmitted, reflected, or scattered radiation. A typical scheme employs optical and other elements to provide excitation light and to selectively collect the emissions.

For example, scanner 110 provides a signal representing the intensities (and possibly other characteristics, such as color) of the detected emissions or reflected wavelengths of light, as well as the locations on the substrate where the emissions or reflected wavelengths were detected. Typically, the signal includes intensity information corresponding to elemental sub-areas of the scanned substrate. The term “elemental” in this context means that the intensities, and/or other characteristics, of the emissions or reflected wavelengths from this area each are represented by a single value. When displayed as an image for viewing or processing, elemental picture elements, or pixels, often represent this information. Thus, in the present example, a pixel may have a single value representing the intensity of the elemental sub-area of the substrate from which the emissions or reflected wavelengths were scanned. The pixel may also have another value representing another characteristic, such as color, positive or negative image, or other type of image representation. Two examples where the signal may be incorporated into data are data files in the form *.dat or *.tif as generated respectively by Affymetrix® Microarray Suite (described in U.S. patent application Ser. No. 10/219,882, incorporated above) or Affymetrix® GeneChip® Operating Software based on images scanned from GeneChip® arrays, and Affymetrix® Jaguar™ software (described in U.S. patent application Ser. No. 09/682,071, incorporated above) based on images scanned from spotted arrays. Examples of scanner systems that may be implemented with embodiments of the present invention include U.S. patent application Ser. Nos. 10/389,194, and 10/913,102 both of which are incorporated by reference above.

Autoloader 143: Illustrated in FIG. 1 is autoloader 143 that is an example of one possible embodiment of an automatic loader that provides transport of one or more probe arrays 140 or more particularly embodiments of adaptor/housing couple 200 used in conjunction with scanner 110 and hybridization station 141.

In some embodiments, autoloader 143 may include a number of components such as, for instance, a magazine, tray, carousel, or other means of holding and/or storing a plurality of probe arrays or a plurality of adaptor/housing couple 200 embodiments; a transport assembly; and a thermal control chamber. For example, some implementations of autoloader 143 may include features for preserving the biological integrity of the probe arrays for extended periods such as, for instance, a period of up to sixteen hours. Also in the present example, in the event of a power failure or error condition that prevents scanning or other processing steps, autoloader 143 will indicate the failure to user 105 and maintain storage temperature for all probe arrays 140 through the use of what may be referred to as an uninterruptable power supply system. The power failure or other error may be communicated to user 105 by one or more methods that could include audible/visual alarm indicators, a graphical user interface, automated paging system, or other means of automated communication. Still continuing with the present example, the power supply system could also support one or more other systems such as scanner 110 or hybridization station 141.

Some embodiments of autoloader 143 may include pre-heating each embodiment of probe array 140 that may include embodiments housed in housing 205 or embodiments without a housing, to a preferred temperature prior to or during particular processing or image acquisition operations. For example, autoloader 143 may employ a thermally controlled chamber to pre-heat one or more probe arrays 140 to the same temperature as the internal environment of scanner 110 prior to transport to the scanner. Similarly, autoloader 143 could bring probe array 140 to the appropriate hybridization temperature prior to loading into hybridization station 141. Also in the present example, autoloader may also employ one or more thermal control operations as post-processing steps such as when autoloader 143 removes each of probe arrays 141 from either scanner 110 or hybridization chamber 141, autoloader 143 may employ one or more environmental or temperature control elements to warm or cool the probe array to a preferred temperature in order to preserve biological integrity.

Many embodiments of autoloader 143 are enabled to provide automated loading/unloading of probe arrays 140 to both hybridization station 141 and/or scanner 110. Also, some embodiments of autoloader 143 may be equipped with a barcode reader, or other means of identification and information storage such as, for instance, magnetic strips, what are referred to by those of ordinary skill in the related art as radio frequency identification (RFID), or one or more microchips associated with each embodiment of probe array 140. For example, autoloader 143 may read or otherwise identify encoded information from the means of identification and information storage that in the present example may include a barcode associated with probe array 140. Autoloader 143 may use the information and/or identifier directly in one or more operations or alternatively may forward the information and/or identifier to instrument control and image analysis applications 172 of computer 150 for processing, where applications 172 may then provide instruction to autoloader 143 based, at least in part, upon the processed information and/or identifier. Also in some implementations, scanner 145 and/or hybridization station 143 may also be similarly equipped with a barcode reader or other means as described above.

Additional examples of autoloaders and probe array storage instruments are described in U.S. patent application Ser. Nos. 10/389,194, titled “System, Method and Product for Scanning of Biological Materials”, filed Mar. 14, 2003; Ser. No. 10/684,160, titled “Integrated High-Throughput Microarray System and Process”, filed Oct. 10, 2003; and U.S. Pat. Nos. 6,511,277; and 6,604,902 each of which is hereby incorporated herein by reference in their entireties for all purposes.

A particular example of autoloader 143 enabled for use with the presently described invention may include one or more robotic instruments or other similar instruments commonly used for high-throughput applications. For example, one possible robotic autoloader 143 instrument could include the Sciclone ALH 3000 robotic handling instrument and associated modular components available form Caliper Life Sciences of Hopkinton Mass. In the present example, the robotic autoloader 143 may be enabled to perform some or all of the functions described above and in particular interface with one or more elements of the present invention for positional arrangement and transport.

For example, various embodiments of robotic autoloader 143 may be enabled to provide mechanical transport of individual implementations of housing 205 and adaptor 100 operatively coupled together. In the present example, adaptor 100 and/or housing 205 may comprise one or more fiducial features that could be specialized for to interface with a robotic arm, conveyor, or other means of transport device capable mechanically capturing and manipulating objects. Such fiducial features could include ridges, tabs, keyed slots or holes enabled to accept some structure such as, for instance a pin or protrusion, or other means to enhance a mechanical interface between two objects.

Further, some embodiment of a robotic autoloader 143 may be enabled to transport trays, well plates, tubes, bottles, cuvettes, or other types of containment devices common to a laboratory environment. Additionally, robotic autoloader 143 may also be enabled to manipulate covers, or other sealing devices associated with each of the aforementioned containment devices such as for instance, placing or removing said sealing elements on each containment device for particular processing steps or protection from the environment. Also, some embodiments of robotic autoloader 143 may be enabled to manipulate the adaptor/housing couple 200 embodiments with positioned in tray 710 or other holding device, where for instance the robotic arm or mechanical movement means could individually add or remove selected adaptor/housing couple 200 embodiments from tray 710 without disturbance to other adaptor/housing couple 200 embodiments. Further, robotic autoloader 143 may be enabled to transport and positionally arrange implementations of processing tray 710 or other types of holding or containment device via a robotic arm or other means. For example, it may be advantageous to move each implementation of tray 710 through various stations associated with the robot in order to achieve high processing efficiency of the associated embodiments of adaptor/housing couple 200.

Also embodiments of a robotic autoloader 143 may comprise the same robot described below with respect to hybridization station 141, where the robot may be enabled to perform some or all of the functions described above with respect to autoloader 143 as well as some or all of the functions described below with respect to hybridization station 141. For example, some embodiments of a high-throughput handling robot are capable of mechanical transport functionality as well as fluid transfer and management functionality.

Hybridization station 141: Embodiments of station 141, as illustrated in FIG. 1, may implement one or more procedures or operations for hybridizing one or more experimental samples to probes associated with one or more probe arrays 140, as well as operations that, for instance, may include exposing each of probe arrays 140 to washes, buffers, stains, or other fluids in a sequential or parallel fashion. Embodiments of station 141 may also include one or more robotic or other similar components as described above with respect to robotic autoloader 143 commonly used for high throughput applications and enabled to interface with one more of the elements of an adaptor/housing couple 200.

As previously described, some embodiments of the present invention may include probe array 140 enclosed in a housing or cartridge such as housing 205. Also, in some embodiments, a plurality of housings 205 or adaptor/housing couple 200 may be placed in a carousel, tray such as processing tray 710, or other means of holding for transport or processing as previously described with respect to autoloader 143 and embodiments described in greater detail below. For example, a carousel or specialized tray or carrier such as tray 710 may be specifically enabled to register a plurality of adaptor/housing couple 200 embodiments in a specific orientation and may enable or improve high throughput processing of each of the plurality of probe arrays 140 associated with housings 205 by providing positive positional registration of each adaptor/housing couple 200 embodiment so that the robotic instrument may carry out processing steps in an efficient and repeatable fashion. In the present example, an embodiment of tray 710 may be enabled to hold up to 24 adaptor/housing 200 embodiments that also may be secured by one or more registration clips 720 to maintain and control the positional arrangement.

For example, hybridization station 141 may be enabled to interface and interact with a plurality of features or elements of adaptor/housing couple 200 to perform one or more processes or operations. In particular, station 141 may interface and interact with specific elements of microfluidic adaptor 100, where adaptor 100 may provide a single interface that is addressable by one or components of station 141, as opposed to the additional complexity associated with user 105 or an instrument interfacing with multiple ports or apertures for processing. In the present example, the single interface may be advantageous because less positional manipulation and interaction with various features and elements of adaptor/housing couple 200 are required. Further description and detail will be provided below with respect to elements of microfluidic adaptor 100.

Embodiments of station 141 could include a plurality of elements enabled to automatically introduce and remove fluids from housing 205 via adaptor 100 without user intervention such as, for instance, one or more sample holders, fluid transfer devices, and fluid reservoirs. For example, applications 172 may direct station 141 to add a specified volume of a particular sample to an associated implementation of adaptor/housing couple 200. In the present example, station 141 removes the specified volume of sample from a reservoir positioned in a sample holder via one of sample transfer pins, pipettes or pipette tips, specialized adaptors, or other means known to those of ordinary skill in the related art. In some embodiments, the sample holder may be thermally controlled in order to maintain the integrity of the samples, reagents, or fluids contained in the reservoirs, for a preferred temperature according to a specific protocol or processing step, or for temperature consistency of the various fluids exposed to probe array 140. The term “reservoir” as used herein could include a vial, tube, bottle, 96 or 384 well plate, or some other container suitable for holding volumes of liquid. Also in the present example, station 141 may employ a vacuum/pressure source, valves, and means for fluid transport known to those of ordinary skill in the related art.

In some embodiments, station 141 may interface with each of one or more of adaptor/housing couple 200 embodiments by moving a fluid transfer device such as, for instance, what may be referred to as a pin or needle such as a dual lumen needle, pipette tip, specialized adaptor or other type of fluid transfer device known in the art in a first direction towards to engage with an interface such as addressable interface 510. For example, as those of ordinary skill in the related art will appreciate, a plurality of fluid transfer devices such as a robotic device comprising a pipettor component coupled to one or more pipette tips may be employed to interface and engage with one or more of interfaces 510 in order to process one or more of probe arrays 140, where a plurality of probe arrays 140 may be processed in parallel. In the present example, station 141 may simultaneously or in a sequential fashion process a plurality of probe arrays 140 by removing a specified aliquot of sample or other type of fluid from each reservoir disposed in one or more sample holders and deliver each sample or fluid to a specified implementation of adaptor/housing couple 200 via an associated interface 510 of adaptor 100.

Station 141 may remove used sample or waste fluids from adaptor/housing couple 200 by, for instance, creating a negative pressure or vacuum through one or more ports associated with interface 510. Alternatively, fluids may be similarly expelled from adaptor/housing couple 200 using a positive pressure of air, gas, or other type of fluid either alone or in combination with the negative pressure, through one or more ports where the positive pressure may cause the undesired fluid to be expelled through one or more channels of adaptor 100 such as waste channel 450. Expelled of removed fluids may be stored in one or more reservoir (not shown) or alternatively may be expelled from station 141 into another waste receptacle or drain. For example, it may be desirable in some implementations for user 105 to recover a sample from adaptor/housing couple 200 and store the recovered sample in an environmentally controlled receptacle in order to preserve the biological integrity. In the present example, a negative pressure may be applied to adaptor/housing couple 200 through fluid transfer port 610 that may be operatively connected to fluid transfer channel 430, where vent port 605 allows the transfer of air via vent channel 440 into housing 205 thus enabling the transfer of the sample to the fluid transfer device. The sample fluid may then be directed to the desired receptacle in station 141.

As those of ordinary skill in the related art will appreciate, the sample content of each reservoir within a sample holder is known so that applications 172 may associate an experimental sample or fluid with a particular embodiment of probe array 140. Station 141 may also provide one or more detectors associated with the sample holder to indicate to applications 172 when a reservoir is present or absent. Additionally, station 141may include one or more implementations of a barcode reader, or other means of identification described above with respect to autoloader 143, enabled to identify each reservoir using an associated barcode identifier.

Some embodiments of station 141 may include one or more detection systems enabled to detect the presence and identity of a fluid within adaptor/housing couple 200. For example, one possible type of detection system may employ what those of ordinary skill in the related art refer to as conductivity measurements. As those of ordinary skill in the related art will appreciate, a conductivity measurement includes a measure of conductance that refers to the ability of a material or fluid to conduct electricity. A variety of factors may affect conductivity, such as the amount of salts or other materials in a liquid, for instance a high salt water solution will be more conductive than distilled water with no mineral content. Solutions can have characteristic conductivity's that may be used for identification purposes. The conductivity measurements may be communicated to one or more elements of applications 172 that may in turn respond by instructing station 141 to perform one or more operations such as, for instance, add a specified fluid, remove fluid, or other type of hybridization or processing operation. For example, one or more features or elements may be built into adaptor/housing couple 200 that station 141 may employ for conductivity measurement. For example, adaptor/housing couple 200 may include one or more elements such as fluid transfer interfaces 405 that are electrically conductive. As described in greater detail below, when adaptor 100 is operatively coupled to housing 205 each of fluid transfer interfaces 405 may protrude through a seal on housing 205 into a chamber that houses probe array 140 such as probe array chamber 220. In the present example, by passing small amounts of electric current from one of interface 405 to the other a measure of conductance of fluids within the chamber may be made so that a determination of fluid type/composition or presence/absence may be made by applications 172 or station 141. Additionally, each of interfaces 405 may be electrically coupled to one or more contacts on addressable interface 510 so that, for instance, station 141 may interface with one or more adaptor/housing couple 200 embodiment to provide electric current to and in turn receive conductance measures or other relevant data. In the present example, such contacts may be employed by applications 172 and/or station 141 to receive other types of data or send information such as for instance to a microchip, or other device that is a component of housing 205 or adaptor 100. Also, in some embodiments direct contact may not be necessary to send/receive, or acquire information where adaptor/housing couple 200 may comprise a battery or other means of electric storage or generation, and communicate with station 141 via radio frequency or optical means such as infra-red transmissions.

Some embodiments of station 141 may provide an environment that promotes the hybridization of a biological target contained in a sample to the probes of the probe array. Some environmental conditions that affect the hybridization efficiency could include temperature, gas bubbles, agitation, oscillating fluid levels, or other conditions that could promote the hybridization of biological samples to probes. For example, station 141 may include a hybridization chamber that may, for instance, include a fluid bath for temperature control. In the present example, applications 172 may control the temperature of the fluid bath or chamber using methods known to those of ordinary skill in the related art. Alternatively, station 141 may employ heating to individual or multiple embodiments of adaptor/housing couple 200 via infra-red type beams known in the art as well as electrically coupled heating elements such as resistance type elements that could be a component of either adaptor 100 or housing 205.

Other environmental conditions that station 141 may provide may include a means to provide or improve mixing of fluids within chamber 220 of housing 205. For example providing a means of shaking adaptor/housing couple 200 to promote inertial movement of fluids and turbulent flow in chamber 220 may include what is generally referred as a plate shaker, rotating carousel, or other shaking instrument. Other sources of fluid mixing could be provided by an ultrasonic source or mechanical source such as for instance a piezo-electric agitation source, or other means of providing mechanical agitation. In the present example, the agitation or shaking means may provide fluidic movement within adaptor/housing couple 200 that may improve the efficiency of hybridization of target molecules in a sample to probe array 140. In some embodiments, a carousel or tray such as tray 710 with one or more implementations of adaptor/housing couple 200 may be immersed in a fluid bath, where there may be one or more ultrasonic agitation sources associated with position of an implementation of housing 205. Alternatively, an ultrasonic agitation source may be incorporated as a component in housing 205 and/or adaptor 100. Other examples of elements and methods for mixing fluids in a chamber are provided in U.S. patent application Ser. No. 11/017,095, titled “System and Method for Improved Hybridization Using Embedded Resonant Mixing Elements”, filed Dec. 20, 2004 which is hereby incorporated by reference herein in its entirety for all purposes.

Additionally, station 141 may provide air or gas to adaptor/housing couple 200 to promote the formation of a bubble. For example, the gas bubble may include ambient air or other type of gas that improves sample hybridization by promoting fluid flow and mixing when, for example, the housing is rotated relative to gravity.

Embodiments of station 141 may also perform what those of ordinary skill in the related art may refer to as post hybridization operations such as, for instance, washes with buffers or reagents, water, labels, or antibodies. For example, staining may include introducing a stain comprising molecules with fluorescent tags that selectively bind to the biological molecules or targets that have hybridized to probe array 140. Additional post-hybridization operations may, for example, include the introduction of what is referred to as a non-stringent buffer into adaptor/housing couple 200 to preserve the integrity of the hybridized array.

Some implementations of station 141 allow for interruption of operations to insert or remove probe arrays, samples, reagents, buffers, or any other materials. After interruption, station 141 may conduct a scan of some or all identifiers associated with probe arrays, samples, carousels, trays, or magazines, user input identifiers, or other identifiers used in the automated process. For example, user 105 may wish to interrupt the process conducted by station 141 to remove a tray of samples and insert a new tray. The interruption is communicated to user 105 by a variety of methods, and the user performs the desired tasks. The user inputs a command for the resumption of the process that may begin with station 141 scanning all available barcode identifiers. Applications 172 determines what has been changed, and makes the appropriate adjustments to procedures and protocols.

Station 141 may also perform operations that do not act directly upon a probe array. Such functions could include the management of fresh versus used reagents and buffers, experimental samples, or other materials utilized in hybridization operations. Additionally, station 141 may include features for leak control and isolation from systems that may be sensitive to exposure to liquids. For example, a user may load a variety of experimental samples into station 141 that have unique experimental requirements. In the present example the samples may have barcode labels with unique identifiers associated with them. The barcode labels could be scanned with a hand held reader or alternatively station 141 could include an internal reader. Alternatively, other means of identification could be used as described above. The user may associate the identifier with the sample and store the data into one or more data files. The sample may also be associated with a specific probe array type that is similarly stored.

Additional examples of hybridization and other type of probe array processing instruments are described in U.S. patent application Ser. No. 10/684,160, titled “Integrated High-Throughput Microarray System and Process”, filed Oct. 10, 2003; and Ser. No. 10/712,860, titled “AUTOMATED FLUID CONTROL SYSTEM AND PROCESS”, filed Nov. 13, 2003, both of which are hereby incorporated by reference herein in their entireties for all purposes.

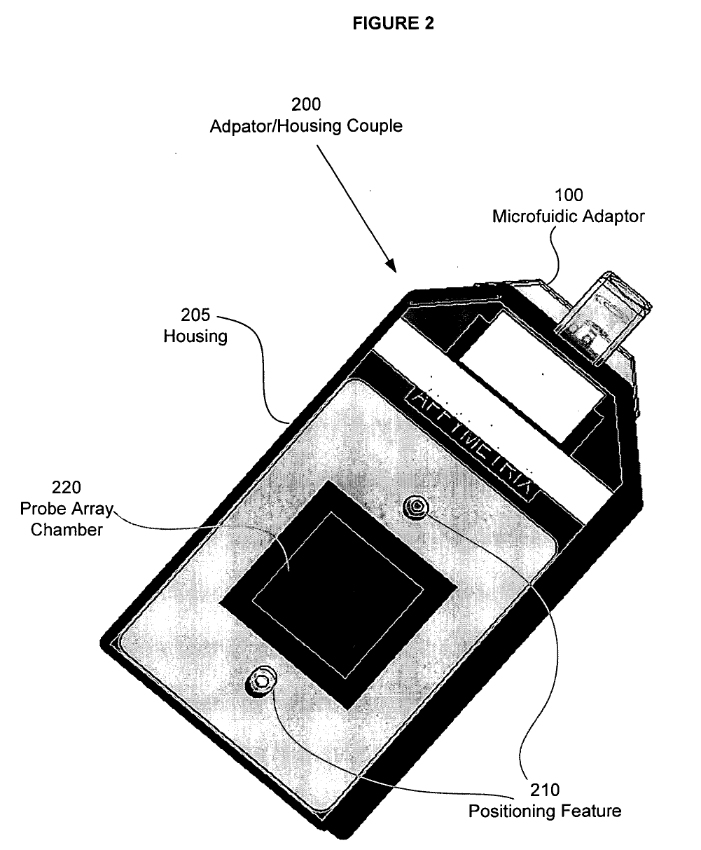

Housing 205: Embodiments of the present invention are enabled to interact with and provide a fluid interface with a housing, cartridge, cap, or other fluid containing structure associated with a biological probe array such as probe array 140. In many implementations, it may be desirable to associate a fluid containing structure with probe array 140 that may improve the efficiency of use of precious samples and reagents such as by reducing volumes required, as well as to improve the ability of instruments to process probe arrays. For example, the association of probe array 140 to housing 205 may be temporary or permanent and where housing 205 may include specialized ports for fluid, air, or gas transfer. In some embodiments, the specialized ports are enabled to interface with automated instruments as well as manual interactions such as from user 105, and in particular elements of adaptor 100 such as, for instance, fluid transfer interfaces 405. In the present example, housing 205 provides a chamber that houses probe array 140, illustrated in FIG. 2 as probe array chamber 220, and enables the sequential addition and removal of various fluids to chamber 220 for contact with the probes associated with probe array 140. Also in the present example, housing 205 may also include one or more elements or otherwise be specifically adapted to provide a means of mixing fluids with the chamber, such as for instance the inclusion of an air or gas bubble, vibration sources, or surface textures and other elements that may create turbulent flow of fluids.

Additional examples of fluid containing structures associated with biological probe arrays are described in U.S. Pat. Nos. 5,945,334; 6,140,044; 6,287,850; 6,399,365; 6,551,817, and 6,733,977, each of which are hereby incorporated by reference herein in their entireties for all purposes. Additional examples are also described in U.S. patent application Ser. No. 10/684,160, incorporated by reference above.

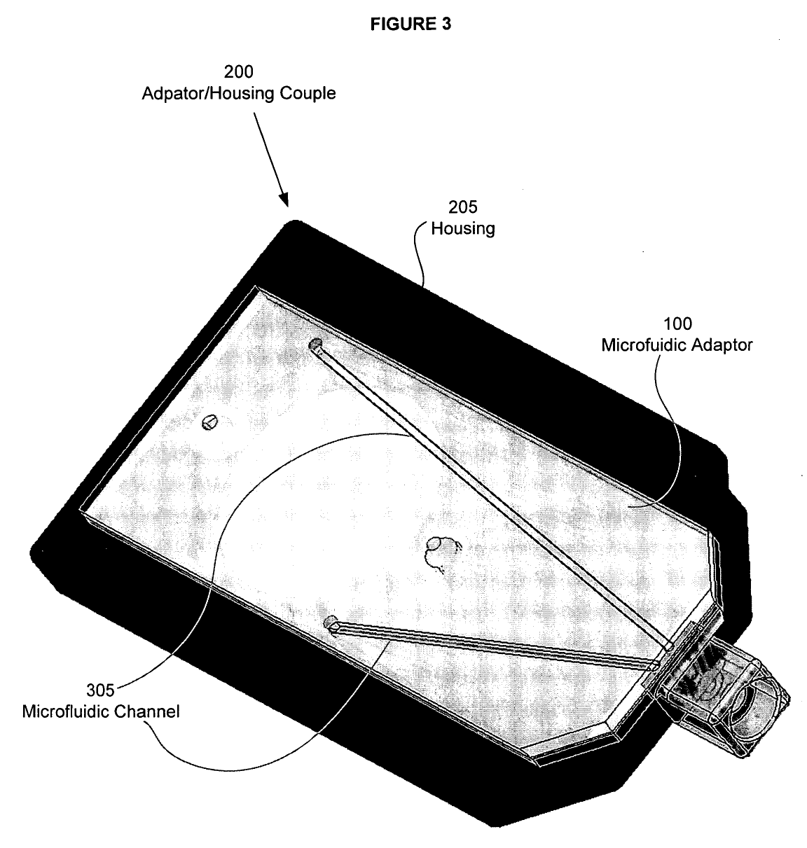

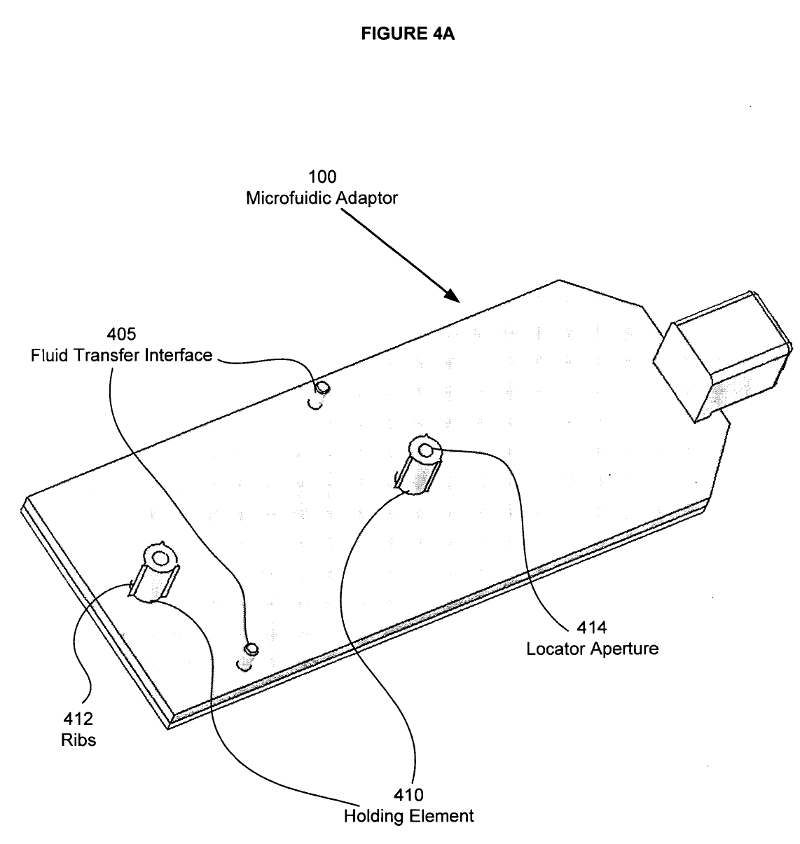

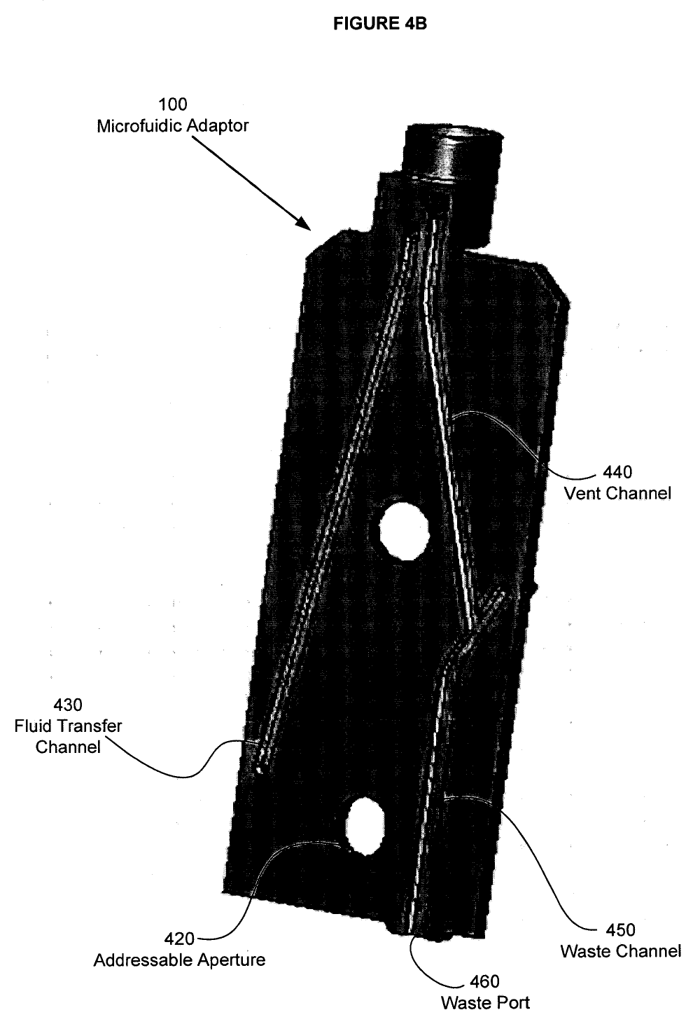

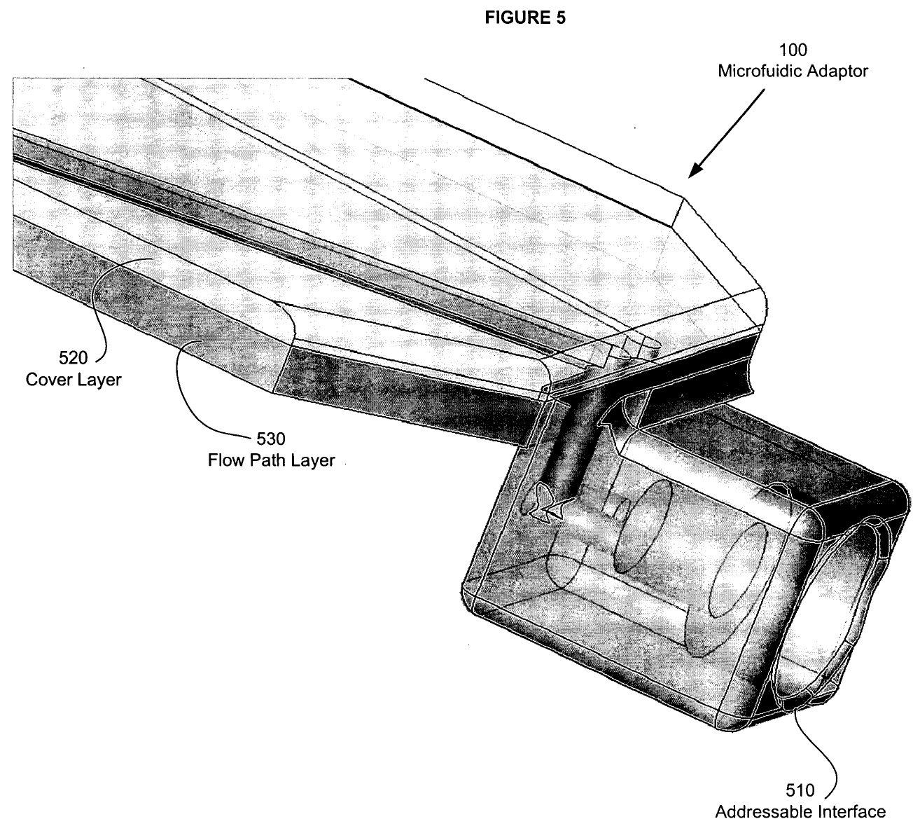

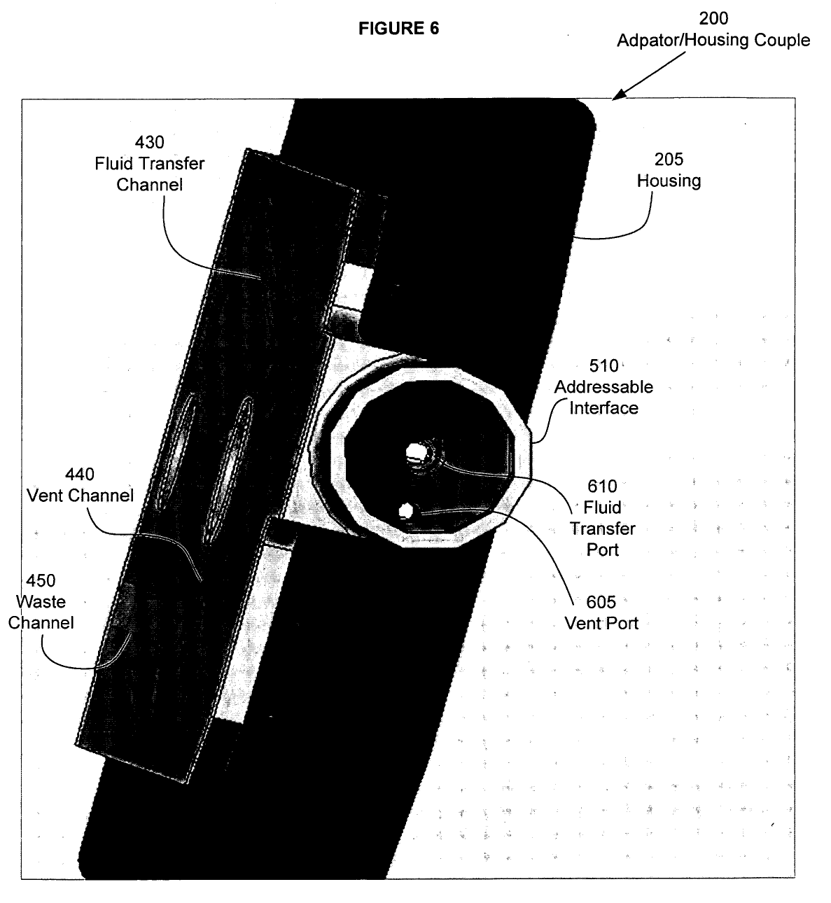

Microfluidic Adaptor 100: Various embodiments of the present invention include a means for providing a single fluid transfer interface between housing 205 associated with probe array 140 and automated instrumentation enabled to perform one or more processing steps and/or user 105. FIGS. 2 through 6 provide illustrative examples of embodiments of microfluidic adaptor 100 that provides such an interface. For example, adaptor 100 may provide an intermediate device between housing 205 and one or more instruments such as hybridization station 141, where adaptor 100 provides an addressable and more efficient means of transferring fluids or gases to and from chamber 220 within housing 205.

Embodiments of microfluidic adaptor 100 may be specifically adapted to operatively couple to housing 205 in a specific orientation. In some embodiments the specific orientation of adaptor 100 with respect to housing 205 may include orienting addressable interface 510 so that it is addressable when positioned in an instrument. For example, the positional relationship of adaptor 100 and housing 205 may include orienting interface 510 along what may be referred to as the Z axis when positioned in station 141, where the Z axis is substantially parallel to the plane of probe array 140 disposed in housing 205 and interface 510 may provide a means of addressing from a particular direction along the Z-axis. In the present example, it may be desirable in high throughput applications, for spatial and other relationships, to position probe array 140 and its associated housing 205 such that the plane defined by the probe array 140 is substantially parallel to the plane defined by the plane of gravitational pull. In the same or other embodiments, the plane defined by the probe array 140 may be substantially parallel to a plane of movement defined by one or more robotic or other elements associated with station 141, where for instance the robotic element may address interface 510 by moving towards a direction defined by or along an axis parallel to the pull of gravity and engaging with interface 510. The robotic element may reversibly move away from the direction defined by the pull of gravity thus disengaging from interface 510.

Interface 510 may also, in some embodiments, comprise a size and shape that enables interaction with a sealing device. For example, it may be desirable in some implementations to provide a fluid and/or airtight seal with interface 510 to reduce the likelihood adverse events that could affect the integrity of adaptor/housing couple 200 for use in high throughput applications such as the introduction of contaminants, evaporative loss of fluid, fluid containment and loss during processing or transport steps, or other undesirable events. A sealing device may interact with a single embodiment of adaptor/housing 200 or alternatively the sealing device may be enabled to interact with a plurality of adaptor/housing 200 embodiments such as, for instance, 24 adaptor/housing 200 embodiments positionally arranged in tray 710. Embodiments of the sealing device may comprise elements made of silicon, rubber, or other non-reactive material suitable for creating a seal against interface 510 when pressed into place via robotic means or by user 105.

Some embodiments of adaptor 100 may be enabled to reversibly engage and disengage from housing 205 where a first position of adaptor 100 may include an engaged relationship with housing 205 and a second position may include a disengaged relationship. For example, adaptor 100 may include one or more elements that define the positional orientation of adaptor 100 with respect to housing 205 in the first engaged position as well as to provide points of interaction with housing 205 that may act hold adaptor 100 in place. Such elements may include one or more holding elements 410 that each interacts with a particular positioning feature 210 of housing 205. Elements 410 may also include features that provide holding power to adaptor 100 such as ribs 412, where ribs 412 may compress or crush against the walls of feature 210 in response to a sufficient force applied to adaptor 100. For instance, each of elements 410 is “pressed” into a corresponding feature 210. The compressed ribs 412 act to provide an outward force against the walls thus holding adaptor 100 securely in place.

Continuing the example from above, embodiments of adaptor 100 may also have addressable aperture 420 in place of elements 410 that may be used for one or more operations by one or more instruments such as, for instance, for accurate positioning of adaptor housing couple 200 in one or more instruments. In the same or other embodiments, adaptor 100 may employ one or more fluid transfer interfaces 405 for securing adaptor 100 to housing 205. In the present example, each of interfaces 405 may interact with a specialized port associated with housing 205 for fluid, air, or gas transfer. Each specialized port may comprise what is referred to as a “septum” that may, for instance, include a rubber seal that may also in some embodiments be coated with Teflon or other type of coating. An implementation of interface 405 may penetrate the septum that substantially prevents the leakage of fluids or gases that may be caused by the interaction between the specialized port and interface 405 or other interfacing element such as a pipette tip. Additionally, the septum provides a force against interface 405 when adaptor 100 is in a first engaged position with housing 205 that acts to hold adaptor 100 in place in the first position. Additionally, the positions of fluid transfer interfaces 405 on adaptor 100 with respect to the positional locations of ports or apertures for receiving interfaces 405 on housing 205 may define the positional relationship between adaptor 100 and housing 205, for instance interfaces 405 may only be able to engage their respective ports in one orientation that reduces the possibility of error caused by incorrect positioning. Similarly, adaptor 100 and/or housing 205 may include one or more fiducial features such as keyed elements, tabs, slots, or other means known in the art for defining positional arrangements.

Embodiments of adaptor 100 may include one or more means for directing fluid flow such as, for instance, microfluidic channels 305. Each of channels 305 may include a specific path from a first location to a second location that may include one or more of fluid transfer interface 405, fluid transfer port 610, vent port 605, or waste port 460. For example, an embodiment of channel 305 may include fluid transfer channel 430 that provides a path between fluid transfer port 610 and fluid transfer interface 405 that interacts with a specialized port associated with housing 205. Similarly, an embodiment of channel 305 may include vent channel 440 may provide a path between vent port 605 and waste channel 450 that for instance may serve to allow air to enter for prevention of siphoning waste material back into housing 205 as well as allowing for efficient expulsion of material from housing 205 breaking what may be referred to as a vacuum or siphon block. Additionally, waste channel 450 also provides a path between an implementation of fluid interface 405 and waste port 460 for directing waste material out of adaptor/housing couple 200.

Those of ordinary skill in the related art will appreciate that each of channels 305 may include an area, volume, or diameter that may be optimized based, at least in part, upon one or more parameters such as what may be referred to as the “Dead Volume”, and desired rate of fluid transfer that could for instance, be affected by the volume or area of channel 305, viscosities of the fluids, surface textures or coatings, turns or bends in channel 305, or other factors that could affect the rate of flow. The term “Dead Volume” as use herein, generally refers to the amount of fluid or gas required to fill the chambers and passages associated with housing 205 as well as adaptor 100. It may be desirable in many applications to minimize the dead volume so that the required volumes of sample and/or reagents necessary are also minimized. For example, it may be desirable that an automated instrument such as hybridization station 141 be enabled to add or remove specific volumes of fluids or gasses such as, for instance, a volume equal to the volume of chamber 220 associated with housing 205, within a specified period of time given certain pressures and forces applied. The area of each of channels 305 may be optimized such that the channel is large enough to enable the transfer within a specified period while being as small as possible to minimize the dead volume.

Microfluidic adaptor 100 may in various embodiments comprise a plurality of components where each component may be constructed of a variety of materials. For example, adaptor 100 may include a laminated or layered structure that includes flow path layer 530 and a cover layer 520. Flow path layer 530 could include various components such as each of channels 305, addressable interface 510, holding elements 410, and transfer interfaces 405. In the present example, flow path layer 530 could be constructed of plastic, nylon, polyethylene, or other suitable material, may be clear or opaque, and may be injection molded, blow molded, casted, or produced by other methods commonly used in the related art. Also in the present example, cover layer 520 could be constructed of similar materials and posses similar characteristics as described above or alternatively could be constructed of metal foil or other similar material where cover layer may define one side and enclose each of channels 305. Cover layer 520 could be heat sealed, ultrasonically welded, or otherwise affixed to bottom layer 530 such that, for instance, the edges of layers 520 and 530 match to create a uniform edge.

In some embodiments, one or more components of adaptor 100 may be specifically constructed to meet one or more specifications of housing 205 and or one or more uses. For example, fluid transfer interface 405 may include needles, pins, or other means of fluid transfer that are specifically constructed to reach a particular depth within housing 205 when in the first engaged position. Those of ordinary skill in the related art will appreciate that damage to housing 205 and/or interface 405 could occur if interface 405 penetrated too deeply into housing 205, alternatively leakage could occur if interface 405 did not penetrate deeply enough. Also in the present example, interface 405 could be constructed of material that is suitable to the intended use of adaptor 100. If adaptor 100 is intended for a single use interface 405 could be constructed of plastic or other inexpensive material, alternatively if adaptor 100 is intended for repeated use interface 405 could be constructed of stainless steel, titanium, or other durable material that may for instance exhibit low leaching properties.

Having described various embodiments and implementations, it should be apparent to those skilled in the relevant art that the foregoing is illustrative only and not limiting, having been presented by way of example only. Many other schemes for distributing functions among the various functional elements of the illustrated embodiment are possible. The functions of any element may be carried out in various ways in alternative embodiments.

Also, the functions of several elements may, in alternative embodiments, be carried out by fewer, or a single, element. Similarly, in some embodiments, any functional element may perform fewer, or different, operations than those described with respect to the illustrated embodiment. Also, functional elements shown as distinct for purposes of illustration may be incorporated within other functional elements in a particular implementation. Also, the sequencing of functions or portions of functions generally may be altered. Certain functional elements, files, data structures, and so on may be described in the illustrated embodiments as located in system memory of a particular computer. In other embodiments, however, they may be located on, or distributed across, computer systems or other platforms that are co-located and/or remote from each other. Numerous other embodiments, and modifications thereof, are contemplated as falling within the scope of the present invention as defined by appended claims and equivalents thereto.

1. An adaptor comprising:
an interface that engages one or more components of an instrument that introduce a fluid to the interface;
a first channel that directs the fluid from the interface to a housing operatively coupled to the adaptor, wherein the housing comprises a chamber and a biological probe array positioned within the chamber; and
a second channel that directs the fluid away from the housing.

2. The adaptor of claim 1, wherein:
the instrument includes a robotic instrument.

3. The adaptor of claim 1, wherein:
the one or more components comprises a pipette tip.

4. The adaptor of claim 3, wherein:
the pipette tip is coupled to a pipettor, wherein the pipettor is a component of a robotic instrument.

5. The adaptor of claim 1, wherein:
the one or more components comprises a needle.

6. The adaptor of claim 1, wherein:
the fluid comprises a sample.

7. The adaptor of claim 1, wherein:
the fluid is selected from the group consisting of a wash, a stain, a buffer, and a reagent.

8. The adaptor of claim 1, wherein:
the adaptor is operatively coupled to the housing via one or more transfer interfaces each engaged to a respective port.

9. The adaptor of claim 8, wherein:
each of the one or more transfer interfaces penetrates a septum of the respective port, wherein the septum prevents leakage of fluid.

10. The adaptor of claim 9, wherein:
the septum provides a force against the transfer interface, wherein the force operatively couples the adaptor to the housing.

11. The adaptor of claim 1, wherein:
the adaptor is operatively coupled to the housing via one or more holding elements.

12. The adaptor of claim 1, wherein:
the fluid contacts the probe array in the chamber.

13. A method of fluid transfer comprising:
engaging one or more components of an instrument to an interface of an adaptor;
introducing a fluid to the interface;
directing the fluid from the interface to a housing operatively coupled to the adaptor, wherein the housing comprises a chamber and a biological probe array positioned within the chamber; and
directing the fluid away from the housing.

14. The method of claim 13, wherein:
the instrument includes a robotic instrument.

15. The method of claim 13, wherein:
the one or more components comprises a pipette tip.

16. The method of claim 15, wherein:
the pipette tip is coupled to a pipettor, wherein the pipettor is a component of a robotic instrument.

17. The method of claim 13, wherein:
the one or more components comprises a needle.

18. The method of claim 13, wherein:
the fluid comprises a sample.

19. The method of claim 13, wherein:
the fluid is selected from the group consisting of a wash, a stain, a buffer, and a reagent.

20. The method of claim 13, wherein:
the adaptor is operatively coupled to the housing via one or more transfer interfaces each engaged to a respective port.

21. The method of claim 20, wherein:
each of the one or more transfer interfaces penetrates a septum of the respective port, wherein the septum prevents leakage of fluid.

22. The method of claim 21, wherein:
the septum provides a force against the transfer interface, wherein the force operatively couples the adaptor to the housing.

23. The method of claim 13, wherein:
the adaptor is operatively coupled to the housing via one or more holding elements.

24. The method of claim 13, wherein:
the fluid contacts the probe array in the chamber.

25. A processing system, comprising:
a robotic instrument comprising one or more components to perform one or more processing steps;
a computer comprising an instrument control application that coordinates each processing step; and
a holding device that registers a plurality of adaptors each operatively coupled to a housing, wherein each adaptor comprises:
an interface that engages a first component of the one or more components, wherein the first component introduce a fluid to the interface according to at least one of the one or more processing steps;
a first channel that directs the fluid from the interface to the housing, wherein the housing comprises a chamber and a biological probe array positioned within the chamber; and
a second channel that directs the fluid away from the housing.
